(19) United States
(12) Patent Application Publication
(10) Pub. No.: US 2026/0067980 A1
(43) Pub. Date: Mar. 5, 2026

(54) COMMUNICATION METHOD, USER EQUIPMENT, AND NETWORK NODE

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/383,149

(22) Filed: Nov. 7, 2025

Related U.S. Application Data
(63) Continuation of application No. PCT/JP2024/017136, filed on May 8, 2024.
(60) Provisional application No. 63/500,966, filed on May 9, 2023.

(51) Int. Cl. H04W 76/27; H04W 74/0833; H04W 76/40

(52) U.S. Cl. CPC H04W 76/27; H04W 74/0833; H04W 76/40

(57) ABSTRACT

A communication method performed by a user equipment in a mobile communication system for providing a multicast/broadcast service (MBS), the communication method including: receiving information from a base station, the information relating to whether session join processing of joining a multicast session is permitted to be executed using a small data transmission (SDT) technique of performing communication with the base station while maintaining a radio resource control (RRC) inactive state; and executing the session join processing using the SDT technique while maintaining the RRC inactive state, based on the information indicating that the session join processing is permitted to be executed using the SDT technique.

### RELATED APPLICATIONS

The present application is a continuation based on PCT Application No. PCT/JP2024/017136, filed on May 8, 2024, which claims the benefit of U.S. Provisional Patent Application No. 63/500966 filed on May 9, 2023. The content of which is incorporated by reference herein in their entirety.

### TECHNICAL FIELD

The present disclosure relates to a communication method, a user equipment, and a network node used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V17.4.0

### SUMMARY

In a first aspect, a communication method is a communication method performed by a user equipment in a mobile communication system for providing a multicast/broadcast service (MBS). The communication method includes: receiving information from a network node, the information relating to whether session join processing of joining a multicast session is permitted to be executed using a small data transmission (SDT) technique of performing communication with the network node while maintaining a radio resource control (RRC) inactive state; and executing the session join processing using the SDT technique while maintaining the RRC inactive state, based on the information indicating that the session join processing is permitted to be executed using the SDT technique.

In a second aspect, a user equipment is a user equipment used in a mobile communication system for providing a multicast/broadcast service (MBS). The user equipment includes: a receiver configured to receive information from a network node, the information relating to whether session join processing of joining a multicast session is permitted to be executed using a small data transmission (SDT) technique of performing communication with the network node while maintaining a radio resource control (RRC) inactive state; and a controller configured to execute the session join processing using the SDT technique while maintaining the RRC inactive state, based on the information indicating that the session join processing is permitted to be executed using the SDT technique.

In a third aspect, a network node is a network node used in a mobile communication system for providing a multicast/broadcast service (MBS). The network node includes a transmitter configured to transmit information to a user equipment, the information relating to whether session join processing of joining a multicast session is permitted to be executed by the user equipment using a small data transmission (SDT) technique of performing communication with the network node while maintaining a radio resource control (RRC) inactive state.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to the embodiment.

FIG. 3 is a diagram illustrating a configuration example of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a flowchart illustrating a basic operation example of the UE according to the embodiment.

FIG. 7 is a diagram illustrating an example of an operation of the mobile communication system according to the embodiment.

### DESCRIPTION OF EMBODIMENTS

A mobile communication system according to an embodiment is described with reference to the drawings. In the description of the drawings, the same or similar parts are denoted by the same or similar reference signs.

### (1) System Configuration

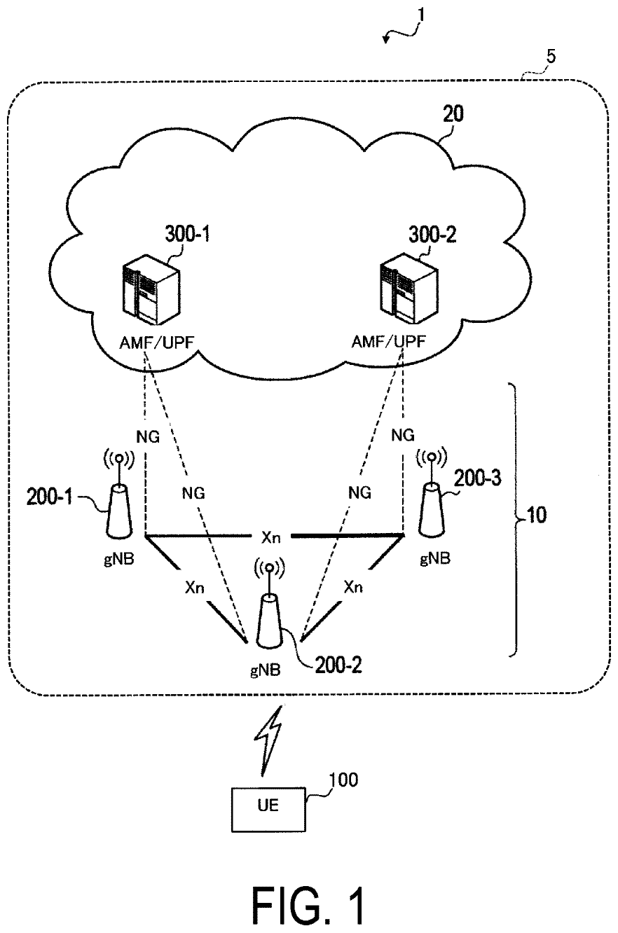

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

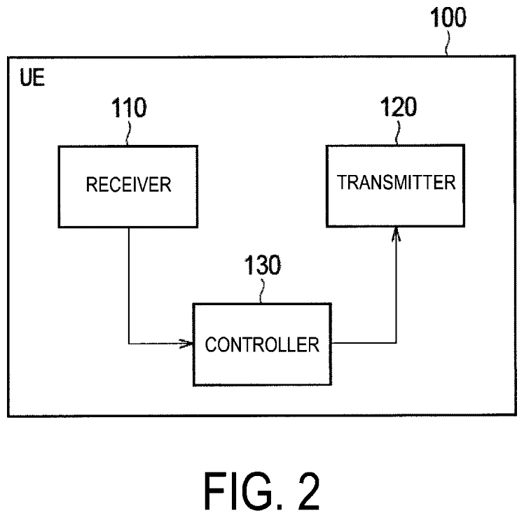

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various reception under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmission under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various types of control and processing in the UE 100. Such processing includes processing of respective layers to be described later. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

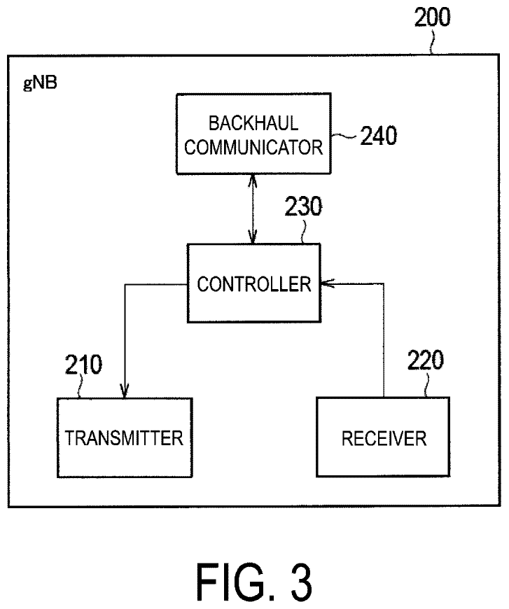

FIG. 3 is a diagram illustrating a configuration example of the gNB 200 (the base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

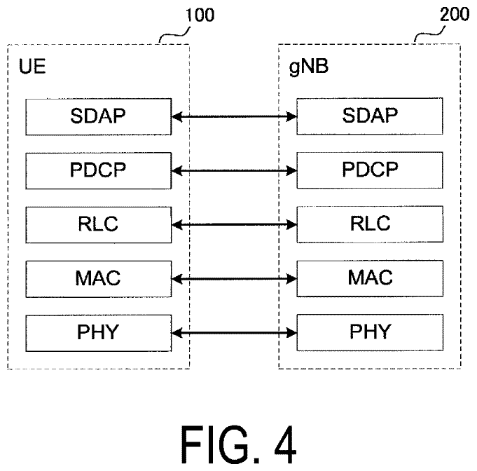

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with CRC (cyclic redundancy code) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

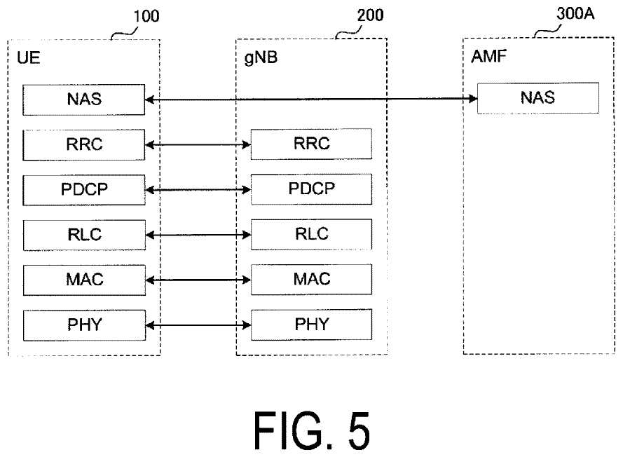

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various types of configuration is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer and the like other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of an MBS session. The UE 100 can receive the broadcast session in any state of the RRC idle state, the RRC inactive state, and the RRC connected state. Note that the MBS session is identified by an MBS session ID (e.g., Temporary Mobile Group Identity (TMGI)).

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 uses a group-common PDCCH with a CRC scrambled by a group-common RNTI (G-RNTI) to schedule a group-common PDSCH scrambled by the G-RNTI.

For the broadcast communication service, the UE 100 receives a broadcast session in the following procedure. First, the UE 100 receives system information block type 20 (SIB20) from the gNB 200. The SIB20 includes a configuration for a multicast control channel (MCCH), which is a type of logical channel. Second, the UE 100 receives the MCCH from the gNB 200 based on the SIB20. The MCCH includes a PTM configuration. The PTM configuration carries a configuration for a multicast traffic channel (MTCH), which is a type of logical channel, and a configuration for a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

In a case of a multicast communication service (also referred to as “MBS multicast”), the same service and the same specific content data are simultaneously provided to a specific UE set. That is, not every UE 100 in the multicast service area is permitted to receive data. The multicast communication services are delivered to the UE 100 using a multicast session that is a type of an MBS session.

The UE 100 can receive a multicast session only after joining the multicast session (session join). Joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (2.2.1) Multicast Reception in RRC Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a dedicated control channel (DCCH). The RRC Reconfiguration message transmits a configuration for an MTCH for multicast session reception and a configuration for a multicast MRB which is an MRB for multicast session. Second, the UE 100 receives an MTCH based on the RRC Reconfiguration message. The MTCH transmits a multicast session (specifically, MBS data belonging to the multicast session). Note that the configuration for the MTCH (MTCH configuration) is MTCH configuration is a configuration for MTCH reception, and includes, for example, at least one selected from the group consisting of a group identifier (G-RNTI), a discontinuous reception configuration (DRX configuration or scheduling information: MTCH transmission ON time, MTCH transmission cycle, reference time and time offset, HARQ retransmission configuration), a layer 2 configuration (PDCP configuration, RLC configuration), and a physical channel configuration (PDCCH configuration, PDSCH configuration, SSB mapping configuration).

### (2.2.2) Multicast Reception in RRC Inactive State

The UE 100 in the RRC inactive state may receive a multicast session (specifically, MBS belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as a “new SIB”) from the gNB 200. The new SIB includes a configuration for a newly introduced MCCH (also referred to as a “multicast MCCH”). Second, the UE 100 in the RRC inactive state receives a multicast MCCH based on the new SIB from the gNB 200. The multicast MCCH includes a PTM configuration. The PTM configuration carries a configuration for an MTCH for multicast session reception and a configuration for a multicast MRB which is an MRB for multicast session. Third, the UE 100 in the RRC inactive state receives an MTCH based on the multicast MCCH. The MTCH transmits a multicast session (specifically, MBS data belonging to the multicast session).

When the gNB 200 configures the UE 100 to receive multicast in the RRC inactive state, the gNB 200 can transmit the PTM configuration using an RRC release message including a suspend configuration to the UE 100. In this case, the UE 100, upon receiving the RRC Release message including the PTM configuration from the gNB 200, transitions to the RRC inactive state and receives the multicast session in the RRC inactive state.

### (3) System Operation Example

Hereinafter, an operation for the multicast reception in the RRC inactive state is described.

The UE 100 needs to have executed processing of joining a multicast session with respect to the CN 20 in order to receive the multicast session. Therefore, a basic scenario is assumed in which the UE 100 interested in receiving a multicast session first executes the processing of joining the multicast session while being in the RRC connected state, second transitions from the RRC connected state to the RRC inactive state, and third receives the multicast session in the RRC inactive state. Note that the UE 100 joining the multicast session may mean that the UE 100 is registered in the CN 20 in association with the multicast session.

However, the UE 100, after transitioning to the RRC inactive state, may be interested in receiving the multicast session. In such a case, the UE 100 may need to transition to the RRC connected state through RRC connection resume in order to execute the processing of joining the multicast session. When the UE 100 transitions to the RRC connected state, a load on each of the UE 100 and the network 5 (in particular, the gNB 200) increases. Therefore, it is not preferable for the UE 100 to perform the RRC connection resume in order to perform the processing of joining the multicast session, from the viewpoint of load reduction.

On the other hand, the mobile communication system 1 supports a small data transmission (SDT) technique that enables communication (transmission of data and/or signaling transmission) with the gNB 200 while the UE 100 is in the RRC inactive state (that is, without transitioning to the RRC connected state).

An SDT procedure is initiated with transmission via a random access channel (RACH) resource configured in system information or a type 1 configured grant (CG) resource configured through dedicated signaling (RRC Release message). For the RACH, the network 5 can configure RA resources of two-stage RA or four-stage RA for SDT. In the following embodiments, an example is mainly described in which RA-SDT that is SDT using random access (RA) is used, but CG-SDT that is SDT using CG may be used. Note that the SDT is enabled on a radio bearer basis, and is initiated by the UE 100 only in a case where an amount of uplink data awaits transmission across all radio bearers for which SDT is enabled is less than a configured amount, a downlink reference signal received power (RSRP) is above a configured threshold, and there is a valid SDT resource.

It is considered that the UE 100 executes the session join processing using such an SDT technique so that the UE 100 remaining in the RRC inactive state joins the multicast session and can receive the multicast in the RRC inactive state. However, as described above, since the UE 100 is assumed to have already joined the session in the basic scenario, the gNB 200 may not need to support the session join processing using the SDT technique.

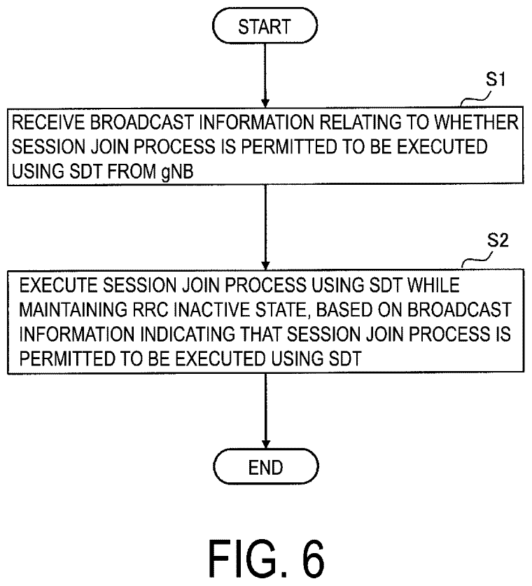

FIG. 6 is a flowchart illustrating a basic operation example of the UE 100 according to the embodiment.

In step S1, the UE 100 receives information from the gNB 200, the information relating to whether the session join processing of joining a multicast session is permitted to be executed using the SDT (SDT technique) for performing communication with the gNB 200 while maintaining the RRC inactive state. In this embodiment, the UE 100 in the RRC inactive state receives broadcast information broadcast from the gNB 200 in the system information block SIB or on the multicast control channel (MCCH).

In step S2, the UE 100 executes the session join processing using the SDT while maintaining the RRC inactive state, based on the broadcast information indicating that the session join processing is permitted to be executed using the SDT.

Accordingly, the UE 100 can execute the session join processing using the SDT technique after confirming that the gNB 200 supports the session join processing using the SDT technique. Therefore, when the gNB 200 does not support the session join processing using the SDT technique, the UE 100 is easy to prevent from executing the session join processing using the SDT technique.

In this embodiment, the SDT is the random access SDT (RA-SDT) for communicating with the gNB 200 during the random access procedure. In step S2, the UE 100 may transmit a non-access stratum (NAS) request message for the session join processing together with a message 3 (Msg3) or a message A (MsgA) transmitted to the gNB 200 during the random access procedure.

In step S2, the UE 100 may receive a NAS response message to the NAS request message together with a message 4 (Msg4) or a message B (MsgB) received from the gNB 200 during the random access procedure.

Further, in step S2, the UE 100 may receive a point-to-multipoint (PTM) configuration together with the NAS response message from the gNB 200, the PTM configuration being required for reception of the multicast session. This makes it easy for the UE 100 in the RRC inactive state to execute multicast reception. Alternatively, the UE 100, after executing the session join processing using the SDT in the RRC inactive state, may acquire the PTM configuration in the MCCH by receiving the MCCH from the gNB 200.

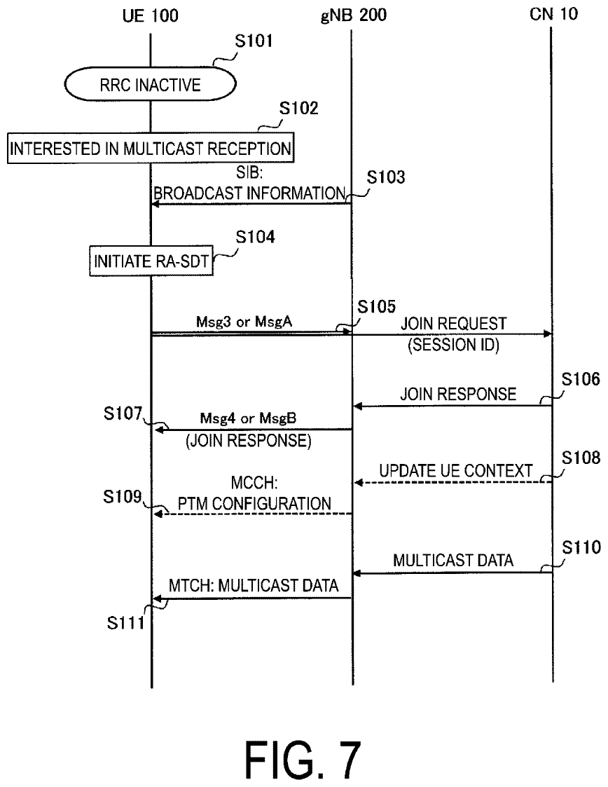

FIG. 7 is a diagram illustrating an example of an operation of the mobile communication system 1 according to the embodiment.

In step S101, the UE 100 is in the RRC inactive state in the cell of the gNB 200.

In step S102, the UE 100 in the RRC inactive state is interested in receiving a multicast session. For example, the UE 100 is interested in receiving a certain multicast session (multicast session #1).

In step S103, the gNB 200 transmits broadcast information relating to whether the session join processing of joining a multicast session is permitted to be executed using the SDT. For example, the gNB 200 may transmit an SIB including an information element indicating that the session join processing of joining a multicast session is permitted or not permitted to be executed using the SDT. In this operation example, assume that the gNB 200 transmits an SIB including an information element indicating that the session join processing of joining a multicast session is permitted to be executed using the SDT.

The UE 100 determines that the session join processing using the SDT is permitted based on the broadcast information received in the SIB from the gNB 200 (cell). In step S104, the UE 100 initiates the RA-SDT.

In step S105, the UE 100 transmits the Msg3 or MsgA to the gNB 200. To be more specific, in the case of the four-stage RA, the UE 100 transmits a random access preamble to the gNB 200 on a physical random access channel (PRACH), the gNB 200 transmits a random access response the UE 100, and the UE 100 transmits the Msg3 to the gNB 200. The transmission of the Msg3 may include transmission of an RRC resume request message. In the case of the two-stage RA, the UE 100 transmits collectively the transmission of the random access preamble and Msg3 as the MsgA to the gNB 200.

In step S105, the UE 100 transmits a NAS message addressed to the AMF 300A in the CN 20 when transmitting the Msg3 or the MsgA. The NAS message is a join request message including a session ID of the multicast session that the UE 100 requests to join. The AMF 300A in the CN 20 receives the join request message from the UE 100. Note that in the case of transmitting the NAS message in the Msg3 or the MsgA with the RRC message, the RRC message may include a container for storing the NAS message (dedicatedNAS-Message IE). The container may be included in the RRC Resume Request message or another RRC message.

In response to receiving the join request message from the UE 100, the AMF 300A in the CN 20 transmits a join request to a Multicast Broadcast Session Management Function (MB-SMF) in the CN 20. The MB-SMF in the CN 20 approves the join request and transmits a join response to the AMF 300A.

In step S106, the AMF 300A in the CN 20 transmits a NAS message (join response message) addressed to the UE 100 in response to receiving the join response from the MB-SMF.

In step S107, the gNB 200 transmits the NAS message (join response message) from the AMF 300A in the CN 20 together with the Msg4 or the MsgB to the UE 100. The Msg4 transmission or the MsgB transmission may include transmission of an RRC Release message for maintaining the UE 100 in the RRC inactive state. The gNB 200 may transmit, to the UE 100, the RRC Release message including a part of the PTM configuration (for example, basic configuration) required for receiving the multicast session #1. Note that in the case of transmitting the NAS message in the Msg4 or the MsgB with the RRC message, the RRC message may include a container for storing the NAS message (dedicatedNAS-Message IE). The container may be included in the RRC Release message, the RRC Resume message, or another RRC message.

In step S108, the AMF 300A in the CN 20 may transmit a UE context update message to the gNB 200. The UE context update message may include the session ID of the multicast session #1 which the UE 100 has already joined as the updated UE context. The gNB 200 recognizes the multicast session #1 which the UE 100 has joined based on the UE context update message. Note that step S108 may be performed before or at the same time as step S106.

In step S109, the gNB 200 may transmit the PTM configuration including a configuration for the multicast session #1 to the UE 100 on the MCCH. When the gNB 200 has transmitted the basic configuration for the multicast session #1 in the RRC Release message, the gNB 200 may transmit the remaining PTM configuration on the MCCH.

In step S110, the CN 20 transmits multicast data of the multicast session #1 to the gNB 200.

In step S111, the gNB 200 transmits the multicast data of the multicast session #1 from the CN 20 to the UE 100 on the MTCH. The UE 100 in the RRC inactive state receives the multicast data of the multicast session #1 on the MTCH from the gNB 200.

Note that, in this operation example, the example is described in which the gNB 200 provides the PTM configuration to the UE 100 in step S107, but a scenario is also assumed in which the gNB 200 cannot provide the PTM configuration to the UE 100 in step S107. In such a scenario, all PTM configurations needed for the UE 100 to perform multicast reception (MTCH reception) need to be provided on the MCCH. However, the gNB 200 may not need to provide such PTM configuration on the MCCH.

Therefore, in step S103, the gNB 200 may transmit the MCCH relating to whether the session join processing of joining a multicast session is permitted to be executed using the SDT, instead of transmitting a block configuration, in the SIB, indicating whether the session join processing of joining a multicast session is permitted to be executed using the SDT.

Here, if the session join processing of joining a multicast session is permitted to be executed using the SDT, the gNB 200 may transmit the MCCH including all information required for the multicast reception. On the other hand, if the session join processing of joining a multicast session is not permitted to be executed using the SDT, the gNB 200 may transmit the MCCH including only a part of the information required for the multicast reception. The UE 100 determines whether the session join processing of joining a multicast session is permitted to be executed using the SDT, based on the content of the MCCH received from the gNB 200.

The UE 100, when executing the session join processing using the SDT, the UE 100 may notify the gNB 200 in step S105 that the processing is to be executed. The notification may be made by transmitting an Msg1 using a specific PRACH resource. Note that the gNB 200 may notify the UE 100 of the specific PRACH resource (PRACH resource for notification of the session join processing using the SDT) in the SIB, on the MCCH, or through the dedicated signaling. Alternatively, the notification may be transmitted in the Msg3. In this case, a recovery cause information element (Resume Cause) may be used in the RRC Resume Request message, or the notification may be transmitted in a new information element. By using the notification, the gNB 200 can optimize the receptions in steps S106 and S108 and the transmissions in steps S107 and S109. For example, by performing the transmission in step S107 after the reception in step S108, the multicast reception configuration can be included in the RRC Request message in step S107.

### (4) Other Embodiments

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items. ” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplementary Notes

Features relating to the embodiments described above are described below as supplements.

### (Supplementary Note 1)

A communication method performed by a user equipment in a mobile communication system for providing a multicast/broadcast service (MBS), the communication method including the steps of:
receiving information from a network node, the information relating to whether session join processing of joining a multicast session is permitted to be executed using a small data transmission (SDT) technique of performing communication with the network node while maintaining a radio resource control (RRC) inactive state; and
executing the session join processing using the SDT technique while maintaining the RRC inactive state, based on the information indicating that the session join processing is permitted to be executed using the SDT technique.

### (Supplementary Note 2)

The communication method according to supplementary note 1, wherein
the receiving includes receiving, by the user equipment in the RRC inactive state, the information broadcast from the network node in a system information block SIB or on a multicast control channel (MCCH).

### (Supplementary Note 3)

The communication method according to supplementary note 1 or 2, wherein
the SDT technique is random access SDT in which the communication is performed during a random access procedure, and
the executing includes transmitting a non-access stratum (NAS) request message for the session join processing together with a message 3 (Msg3) or a message A (MsgA) transmitted to the network node during the random access procedure.

### (Supplementary Note 4)

The communication method according to supplementary note 3, wherein
the executing further includes receiving a NAS response message to the request message together with a message 4 (Msg4) or a message B (MsgB) received from the network node during the random access procedure.

### (Supplementary Note 5)

The communication method according to supplementary note 4, wherein
the executing further includes receiving a point-to-multipoint (PTM) configuration together with the response message from the network node, the PTM configuration being required for reception of the multicast session.

### (Supplementary Note 6)

A user equipment used in a mobile communication system for providing a multicast/broadcast service (MBS), the user equipment including:
a receiver configured to receive information from a network node, the information relating to whether session join processing of joining a multicast session is permitted to be executed using a small data transmission (SDT) technique of performing communication with the network node while maintaining a radio resource control (RRC) inactive state; and
a controller configured to execute the session join processing using the SDT technique while maintaining the RRC inactive state, based on the information indicating that the session join processing is permitted to be executed using the SDT technique.

### (Supplementary Note 7)

A network node used in a mobile communication system for providing a multicast/broadcast service (MBS), the network node including:
a transmitter configured to transmit information to a user equipment, the information relating to whether session join processing of joining a multicast session is permitted to be executed by the user equipment using a small data transmission (SDT) technique of performing communication with the network node while maintaining a radio resource control (RRC) inactive state.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method performed by a user equipment in a mobile communication system for providing a multicast/broadcast service (MBS), the communication method comprising:
receiving information from a network node, the information relating to whether session join processing of joining a multicast session is permitted to be executed using a small data transmission (SDT) technique of performing communication with the network node while maintaining a radio resource control (RRC) inactive state; and
executing the session join processing using the SDT technique while maintaining the RRC inactive state, based on the information indicating that the session join processing is permitted to be executed using the SDT technique.

2. The communication method according to claim 1, wherein
the receiving comprises receiving, by the user equipment in the RRC inactive state, the information broadcast from the network node in a system information block SIB or on a multicast control channel (MCCH).

3. The communication method according to claim 1, wherein
the SDT technique is random access SDT in which the communication is performed during a random access procedure, and
the executing comprises transmitting a non-access stratum (NAS) request message for the session join processing together with a message 3 (Msg3) or a message A (MsgA) transmitted to the network node during the random access procedure.

4. The communication method according to claim 3, wherein
the executing further comprises receiving a NAS response message to the request message together with a message 4 (Msg4) or a message B (MsgB) received from the network node during the random access procedure.

5. The communication method according to claim 4, wherein
the executing further comprises receiving a point-to-multipoint (PTM) configuration together with the response message from the network node, the PTM configuration being required for reception of the multicast session.

6. A user equipment used in a mobile communication system for providing a multicast/broadcast service (MBS), the user equipment comprising:
a receiver configured to receive information from a network node, the information relating to whether session join processing of joining a multicast session is permitted to be executed using a small data transmission (SDT) technique of performing communication with the network node while maintaining a radio resource control (RRC) inactive state; and
a controller configured to execute the session join processing using the SDT technique while maintaining the RRC inactive state, based on the information indicating that the session join processing is permitted to be executed using the SDT technique.

7. A network node used in a mobile communication system for providing a multicast/broadcast service (MBS), the network node comprising:
a transmitter configured to transmit information to a user equipment, the information relating to whether session join processing of joining a multicast session is permitted to be executed by the user equipment using a small data transmission (SDT) technique of performing communication with the network node while maintaining a radio resource control (RRC) inactive state.
